(19) United States
(12) Patent Application Publication
(10) Pub. No.: US 2026/0211079 A1
(43) Pub. Date: Jul. 23, 2026

(54) TARGET RECOGNITION APPARATUS,TARGET RECOGNITION METHOD, AND TARGET RECOGNITION PROGRAM

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Shoh KOIDE, Tokyo (JP); Meguru ITO, Tokyo (JP)

(21) Appl. No.: 19/455,096

(22) Filed: Jan. 21, 2026

(30) Foreign Application Priority Data
Jan. 23, 2025 (JP) 2025-009964

(51) Int. Cl. G01S 7/41; G01S 13/72; G01S 13/931

(52) U.S. Cl. CPC G01S 7/412; G01S 13/723; G01S 13/931; G01S 2013/93271; G01S 2013/93272; G01S 2013/93274

(57) ABSTRACT

A target recognition apparatus acquires target detection information from first and second sensors having detection areas adjacent in terms of azimuth angle. The target recognition apparatus continuously uses the target detection information as valid information within a handoff region in response to a first target detected within a first validation subject region and of which the target detection information is acquired being subsequently detected within the handoff region and outside the first validation subject region. The first validation subject region is a predetermined area that is a portion of a detection area of the first sensor. The handoff region region is a region in which the first and second validation subject regions are adjacent, and includes at least portions of the first and second validation subject regions. The second validation subject region is a predetermined area that is a portion of a detection area of the second sensor.

### CROSS-REFERENCE TO RELATED APPLICATIONS

This application is based on and claims the benefit of priority from Japanese Patent Application No. 2025-009964, filed on Jan. 23, 2025. The entire disclosure of the above application is incorporated herein by reference.

### BACKGROUND

### Technical Field

The present disclosure relates to a target recognition apparatus, a target recognition method, and a target recognition program.

### Related Art

In cases in which an external sensor such as a millimeter-wave radar monitors the vicinity of a vehicle, a plurality of external sensors may be set to widen a monitorable region. When the plurality of external sensors are used to widen the monitorable region in this manner, when tracking a target that moves from one area to another adjacent area, appropriate target tracking can be implemented by information on the target detected by one external sensor being handed off to the information detected by another external sensor. If this handoff is inappropriately performed, target tracking may not be appropriately performed and appropriate vehicle control may be impeded.

### SUMMARY

One aspect of the present disclosure provides a target recognition apparatus configured to recognize a target in a vicinity of a vehicle when mounted in the vehicle. The target recognition apparatus acquires target detection information from a first sensor and a second sensor that are radar sensors having detection areas that are adjacent in terms of azimuth angle. The target recognition apparatus generates a recognition result of the target based on first target detection information that is the target detection information from the first sensor and second target detection information that is the target detection information from the second sensor. When a predetermined area that is a portion of the detection area and is in a central area in terms of azimuth angle is set as a validation subject area, the validation subject area of the first sensor is set as a first validation subject area and the validation subject area of the second sensor is set as a second validation subject area, and a predetermined region in which the first validation subject area and the second validation subject area are adjacent and includes at least a portion of the first validation subject area and a portion of the second validation subject area is set as a handoff region, in response to a first target that is the target detected within the first validation subject region and of which the first target information is acquired being subsequently detected within the handoff region and outside the first validation subject region, the target recognition apparatus continuously uses the first target detection information as valid information within the handoff region.

### BRIEF DESCRIPTION OF THE DRAWINGS

In the accompanying drawings:

FIG. 1 is a schematic diagram illustrating an overview of target recognition in a vehicle to which an embodiment of the present disclosure is applied;

FIG. 2 is a block diagram illustrating an overall configuration of an in-vehicle system shown in FIG. 1;

FIG. 3 is a block diagram illustrating an overall functional configuration implemented by a target recognition apparatus shown in FIG. 2;

FIG. 4 is a schematic diagram illustrating an operational overview of the target recognition apparatus shown in FIG. 3;

FIG. 5 is a schematic diagram illustrating an operational overview of the target recognition apparatus shown in FIG. 3;

FIG. 6 is a flowchart illustrating an operational overview of the target recognition apparatus shown in FIG. 3;

FIG. 7 is a schematic diagram illustrating an operational overview of the target recognition apparatus shown in FIG. 3;

FIG. 8 is a schematic diagram illustrating an operational overview of the target recognition apparatus shown in FIG. 3;

FIG. 9 is a schematic diagram illustrating an operational overview of the target recognition apparatus shown in FIG. 3;

FIG. 10 is a schematic diagram illustrating an operational overview of the target recognition apparatus shown in FIG. 3;

FIG. 11 is a schematic diagram illustrating an operational overview of the target recognition apparatus shown in FIG. 3;

FIG. 12 is a table illustrating determination results corresponding to a specific example shown in FIG. 9 to FIG. 11;

FIG. 13 is a schematic diagram illustrating an operational overview of the target recognition apparatus shown in FIG. 3; and

FIG. 14 is a schematic diagram illustrating an operational overview of the target recognition apparatus shown in FIG. 3.

### DESCRIPTION OF THE EMBODIMENTS

JP 2024-054702 A describes a target tracking apparatus that includes a first acquiring unit, a second acquiring unit, and a handoff unit. The first acquiring unit acquires first information on a first target from a first external sensor that monitors a first region positioned in a first direction relative to a vehicle. The second acquiring unit acquires second information on a second target from a second external sensor that monitors a second region positioned in a second direction relative to the vehicle that differs from the first direction. The handoff unit performs handoff based on handoff determination that determines whether handoff of the first information and the second information is possible when the first target and the second target are simultaneously detected in an overlapping region of the first region and the second region. In addition, the handoff unit determines that handoff is possible when at least the following conditions are met: identity of the targets; a position condition based on an angle relative to a travel direction of the vehicle and distance from the vehicle; a vehicle speed condition regarding travel speed of the vehicle; and a steering condition regarding a steering direction and a turning radius when the vehicle turns.

In this type of technology, further improvement in reliability of target information is desired. The present disclosure has been provided in light of the circumstances described above as an example, and the like.

A first aspect of the present disclosure provides a target recognition apparatus configured to recognize a target in a vicinity of a vehicle when mounted in the vehicle. The target recognition apparatus includes: a detection information acquiring unit that acquires target detection information from a first sensor and a second sensor that are radar sensors having detection areas that are adjacent in terms of azimuth angle; and a recognition result generating unit that generates a recognition result of the target based on first target detection information that is the target detection information from the first sensor and second target detection information that is the target detection information from the second sensor. The recognition result generating unit, when a predetermined area that is a portion of the detection area and is in a central area in terms of azimuth angle is set as a validation subject area, the validation subject area of the first sensor is set as a first validation subject area and the validation subject area of the second sensor is set as a second validation subject area, and a predetermined region in which the first validation subject area and the second validation subject area are adjacent and includes at least a portion of the first validation subject area and a portion of the second validation subject area is set as a handoff region, and a first target that is the target detected within the first validation subject region and of which the first target information is acquired is subsequently detected within the handoff region and outside the first validation subject region, continuously uses the first target detection information as valid information within the handoff region.

A second aspect of the present disclosure provides a target recognition method for recognizing a target in a vicinity of a vehicle. The target recognition method includes: acquiring target detection information from a first sensor and a second sensor that are radar sensors having detection areas that are adjacent in terms of azimuth angle; and generating a recognition result of the target based on first target detection information that is the target detection information from the first sensor and second target detection information that is the target detection information from the second sensor. In generating the recognition result, when a predetermined area that is a portion of the detection area and is in a central area in terms of azimuth angle is set as a validation subject area, the validation subject area of the first sensor is set as a first validation subject area and the validation subject area of the second sensor is set as a second validation subject area, and a predetermined region in which the first validation subject area and the second validation subject area are adjacent and includes at least a portion of the first validation subject area and a portion of the second validation subject area is set as a handoff region, and a first target that is the target detected within the first validation subject region and of which the first target information is acquired is subsequently detected within the handoff region and outside the first validation subject region, the first target detection information is continuously used as valid information within the handoff region.

A third aspect of the present disclosure provides a target recognition program executable by a target recognition apparatus configured to recognize a target in a vicinity of a vehicle when mounted in the vehicle. The target recognition program includes, as processes performed by the target recognition apparatus: a process for acquiring target detection information from a first sensor and a second sensor that are radar sensors having detection areas that are adjacent in terms of azimuth angle; and a process for generating a recognition result of the target based on first target detection information that is the target detection information from the first sensor and second target detection information that is the target detection information from the second sensor. In the process for generating the recognition result, when a predetermined area that is a portion of the detection area and is in a central area in terms of azimuth angle is set as a validation subject area, the validation subject area of the first sensor is set as a first validation subject area and the validation subject area of the second sensor is set as a second validation subject area, and a predetermined region in which the first validation subject area and the second validation subject area are adjacent and includes at least a portion of the first validation subject area and a portion of the second validation subject area is set as a handoff region, and a first target that is the target detected within the first validation subject region and of which the first target information is acquired is subsequently detected within the handoff region and outside the first validation subject region, the first target detection information is continuously used as valid information within the handoff region.

Here, elements may be given reference numbers in parentheses in each section of the application documents. However, the reference numbers merely indicate examples of corresponding relationships between the elements and specific means described according to the embodiments described hereafter. Therefore, the present disclosure is not limited in any way by the reference numbers described above.

### Embodiments

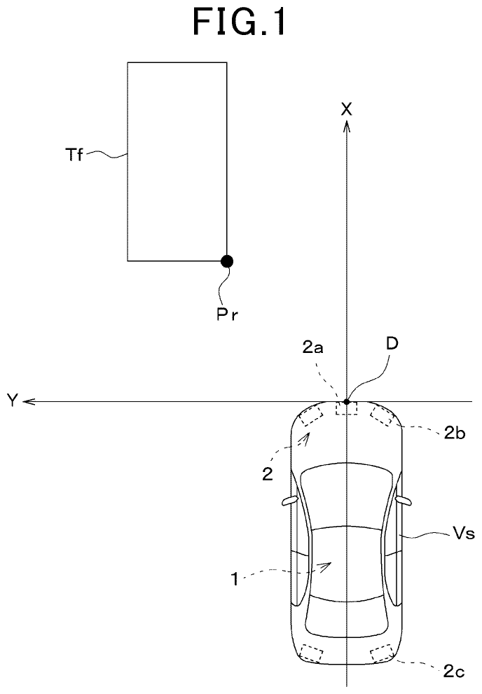

Exemplary embodiments and specific examples of the present disclosure will hereinafter be described with reference to the drawings as appropriate. With reference to FIG. 1, an in-vehicle system 1 is mounted in a vehicle and thereby configured to perform various operations of the vehicle. The vehicle in which the in-vehicle system 1 is mounted is referred to, hereafter, as an “own vehicle Vs”.

According to the present embodiment, the in-vehicle system 1 includes a radar sensor 2 for detecting a target in the vicinity of the own vehicle Vs. The in-vehicle system 1 is configured to display information to an occupant of the own vehicle Vs, perform advanced driver-assistance system (ADAS) operations, and the like based on the detection results. Here, the “target” is a concept including not only an “object” that is a three-dimensional object but also a two-dimensional object such as a road marking. However, in the present disclosure, the “target” to be detected by the radar sensor 2 may be an object such as another vehicle.

The radar sensor 2 has a configuration as a so-called millimeter-wave radar that detects an object to be recognized, that is, a target, by transmitting and receiving radar waves in the millimeter-wave band that are electromagnetic waves. A plurality of radar sensors 2 are mounted in the own vehicle Vs. Specifically, according to the present embodiment, a front radar sensor 2a, a front-side radar sensor 2b, and a rear-side radar sensor 2c are provided as the radar sensors 2.

The front radar sensor 2a is disposed in a central portion in a vehicle lateral direction of a front face portion of the own vehicle Vs such as to detect a target ahead of the own vehicle Vs. The front-side radar sensor 2b is disposed in each of both end portions in the vehicle lateral direction of the front face portion of the own vehicle Vs such as to detect a target to the side of the own vehicle Vs toward the front. The rear-side radar sensor 2c is disposed in each of both end portions in the vehicle lateral direction of a rear face portion of the own vehicle Vs such as to detect a target to the side of the own vehicle Vs toward the rear.

According to the present embodiment, the in-vehicle system 1 is configured to actualize a so-called multi-radar fusion technology in which a target in the vicinity of the own vehicle Vs is recognized based on detection results from a plurality of radar sensors 2 mounted at differing positions. The term “fusion” is used hereafter to mean “multi-radar fusion”, that is, integration of detection results from a plurality of radar sensors 2, rather than a typical meaning that is integration of detection results from the radar sensor 2 and another type of sensor (such as a camera).

Here, “recognition” herein refers to a concept that is narrower than “detection”, which is a broader concept including mere presence or absence. For example, “recognition” herein means not only recognition of the presence or absence of a target, but also acquisition of an attribute thereof. For example, the “attribute” includes at least one of size, type, position, orientation, manner of relative movement, and collision probability. The “type” includes pedestrian, vehicle, and the like.

As shown in FIG. 1, the in-vehicle system 1 is configured to recognize a relative position, a relative movement direction, a relative speed, and the like of a target relative to the own vehicle Vs using two-dimensional coordinates of which a point of origin is a predetermined reference position D on the own vehicle Vs. The reference position D is a central position in the vehicle lateral direction on a front end of the own vehicle Vs. The vehicle lateral direction is a direction perpendicular to an overall vehicle longitudinal direction and also perpendicular to a vehicle height direction. The overall vehicle longitudinal direction is an advancing direction when the own vehicle Vs travels forward and straight ahead. The vehicle height direction is a direction parallel to a direction in which gravity acts when the own vehicle Vs is placed on a horizontal plane in a state allowing travel. In addition, in accordance with common practice in ADAS system disclosures, a forward direction parallel to the overall vehicle longitudinal direction of the vehicle Vs is a positive X-axis direction, and a lateral direction perpendicular to the forward direction and also perpendicular to the vehicle height direction is a Y-axis direction.

FIG. 1 schematically shows, as an example, a case in which another vehicle present ahead and to the left the own vehicle Vs is recognized as a target. In FIG. 1, a fusion target Tf is a target recognized through fusion. The fusion target Tf is indicated by a rectangle calculated based on observation points including a representative point Pr. The observation point is a point corresponding to a position at which an object reflects a radar wave. The observation point may also be referred to as a “reflection point”, a “distance measurement point”, or a “measurement point”. The representative point Pr is a point representing a position of the rectangle calculated based on a group of a plurality of observation points and is prescribed based on the shape of the rectangle. Typically, the representative point Pr is a corner point closest to the vehicle Vs.

### In-Vehicle System

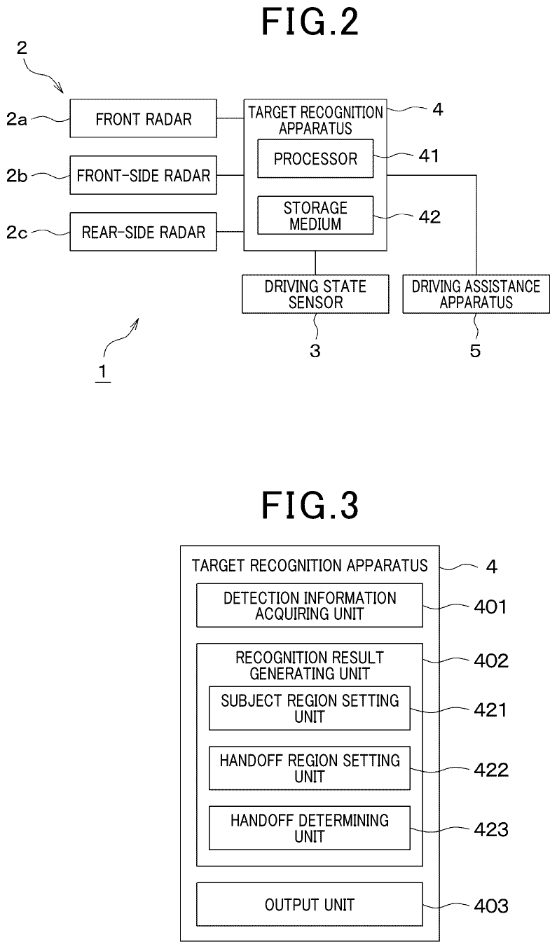

FIG. 2 is a block diagram of an overall system configuration of the in-vehicle system 1. As shown in FIG. 2, the in-vehicle system 1 includes a driving state sensor 3, a target recognition apparatus 4, and a driving assistance apparatus 5, in addition to the radar sensors 2. The radar sensors 2 and the driving state sensor 3 are connected to the target recognition apparatus 4 to be capable of communicating signals or information to the target recognition apparatus 4 by inputting detection results to the target recognition apparatus 4.

The driving state sensor 3 is provided to detect various quantities related to a driving state of the own vehicle Vs. The “driving state” includes a driving operation state, a driving behavior state, and a traveling environment state of the own vehicle Vs. The “driving operation state” is a state of driving operation input made to the own vehicle Vs by a driver of the own vehicle V or the driving assistance apparatus 5. For example, the driving operation state includes an amount of steering, throttle opening, an amount of brake operation, and shift range. The “driving behavior state” refers to a state related to movement or behavior of the own vehicle Vs. For example, the driving behavior state includes vehicle speed, acceleration, and yaw rate. The “travelling environment state” refers to a state of an environment surrounding the own vehicle Vs other than a state of presence of a target. For example, the travelling environment state includes brightness, weather, and a road surface state surrounding the own vehicle V.

The target recognition apparatus 4 is configured to perform a recognition operation for a target in the vicinity of the own vehicle Vs based on the detection information from the radar sensors 2 and the driving state sensor 3. Specifically, the target recognition apparatus 4 is a target recognition electronic control unit (ECU) configured by an in-vehicle microcomputer. The target recognition apparatus 4 includes a processor 41 and a storage medium 42. The processor 41 and the storage medium 42 are connected to be capable of communicating information. In addition, the target recognition apparatus 4 is configured to actualize a predetermined function for recognizing a target in the vicinity of the own vehicle Vs by the processor 41 reading and running a computer program from the storage medium 42.

The processor 41 includes at least a single calculation unit that is configured as a central processing unit (CPU) or a microprocessor unit (MPU), and peripheral circuits thereof. The storage medium 42 includes, among various types of non-transitory, tangible storage media such as a random access memory (RAM), a read-only memory (ROM), and a non-volatile rewritable memory, at least the RAM, and the ROM or the non-volatile rewritable memory. The non-volatile rewritable memory is a storage device that allows information to be rewritten while power is turned on, but holds information in a non-rewritable manner while power is interrupted. For example, the non-volatile rewritable memory is a flash memory. The storage medium 42 stores therein the above-described computer program, as well as various types of data such as initial values, maps, and look-up tables required to run the computer program. Details of the function provided by the target recognition apparatus 4 will be described hereafter.

The driving assistance apparatus 5 has a configuration as an in-vehicle microcomputer that controls a drive force generation mechanism, a drive force transmission mechanism, a braking mechanism, and the like of the own vehicle Vs. Specifically, according to the present embodiment, the driving assistance apparatus 5 is a so-called driving automation ECU and is configured to actualize a driving automation function of the own vehicle Vs.

“Driving automation” refers to actualization of any of driving automation levels from level 1 to level 5 prescribed by standard SAE J3016 published by SAE International. That is, “driving automation” includes “driving assistance” and “automated driving”. “Driving assistance” includes “driving assistance” of a narrow definition in which both a longitudinal-direction vehicle driving control subtask and a lateral-direction vehicle driving control subtask are not simultaneously performed, and “advanced driving assistance” in which both are simultaneously performed. The longitudinal-direction vehicle driving control subtask is start, acceleration, deceleration, and stop. The lateral-direction vehicle driving control subtask is steering.

### Target Recognition Apparatus

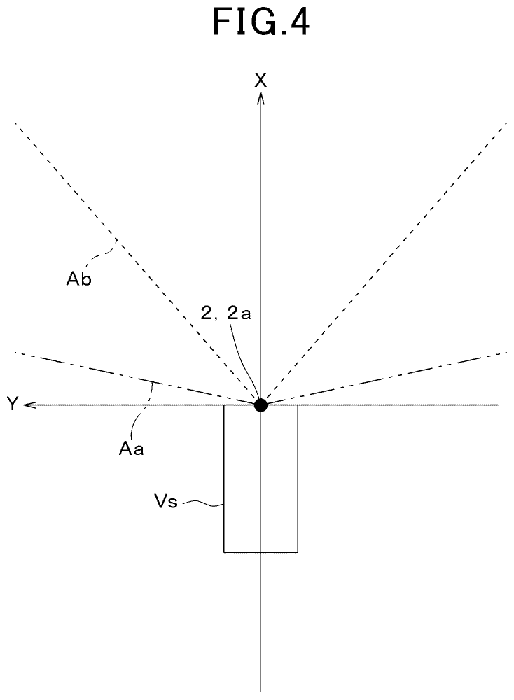

As shown in FIG. 3, the target recognition apparatus 4 includes, as functional configurations actualized on an in-vehicle microcomputer through execution of a computer program, a detection information acquiring unit 401, a recognition result generating unit 402, and an output unit 403. An overview of target recognition is shown in FIG. 4 and subsequent drawings. Details of the functional configurations of the target recognition apparatus 4 will be described below with reference to the drawings.

The detection information acquiring unit 401 acquires the detection information from the radar sensors 2 and the driving state sensor 3. That is, the detection information acquiring unit 401 receives the detection information from the radar sensors 2 and the driving state sensor 3, and stores and holds a predetermined amount as needed. The recognition result generating unit 402 generates a target recognition result by performing a target recognition operation based on the detection information acquired by the detection information acquiring unit 401. The output unit 403 outputs the target recognition result generated by the recognition result generating unit 402 to the driving assistance apparatus 5.

The recognition result generating unit 402 includes a subject region setting unit 421, a handoff region setting unit 422, and a handoff determining unit 423. Details of these functional configurations will be described below.

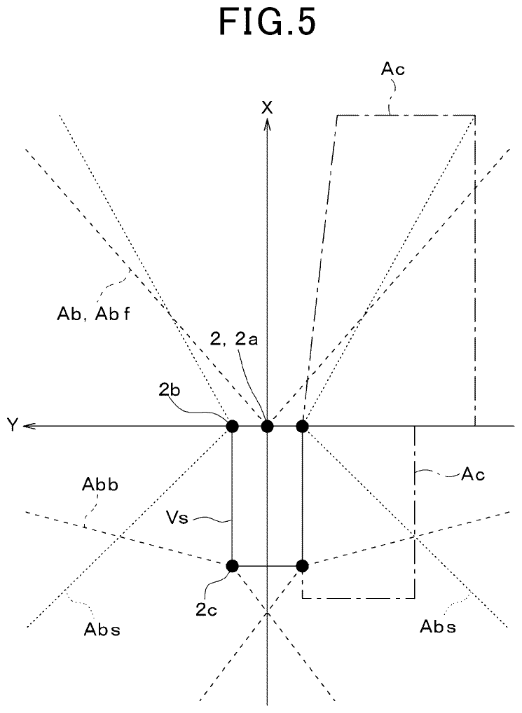

The subject region setting unit 421 sets a validation subject region Ab within a detection range Aa, as shown in FIG. 4 and FIG. 5, for each of the plurality of radar sensors 2. The detection range Aa is a maximum azimuth angle range over which the radar sensor 2 is able to detect a target. The detection range Aa typically has a shape that extends symmetrically to the left and right about a boresight axis. Here, for simplicity of illustration, FIG. 4 shows the detection range Aa and the validation subject region Ab of the radar sensor 2 using, as an example, the front radar sensor 2a of which the boresight axis coincides with the X axis.

The validation subject region Ab is a portion of the detection range Aa and is a predetermined range in a central area in terms of azimuth angle. That is, when the detection range Aa is a range of ±α degrees about the boresight axis, and the validation subject region Ab is a range of ±β degrees about the boresight axis, α>β. Values of α and β may differ among the front radar sensor 2a, the front-side radar sensor 2b, and the rear-side radar sensor 2c. Because detection accuracy of the radar sensor 2 decreases in wide-angle regions, the validation subject region Ab is set as a region in which the detection accuracy is favorable. The “wide-angle region” refers to both ends of the detection range Aa in terms of azimuth angle.

As shown in FIG. 5, the validation subject region Ab of the front radar sensor 2a is referred to as a front subject region Abf. In a similar manner, the validation subject region Ab of the front-side radar sensor 2b is referred to as a front-side subject region Abs. In addition, the validation subject region Ab of the rear-side radar sensor 2c is referred to as a rear-side subject region Abb. To avoid complexity in illustration, the detection range Aa is omitted in FIG. 5.

The handoff region setting unit 422 sets a handoff region Ac shown in FIG. 5. The handoff region Ac is a region set for handoff of the target detection information between the radar sensors 2 having adjacent detection ranges Aa in terms of azimuth angle. Specifically, according to the present embodiment, the handoff region Ac is set as a predetermined region including at least a portion of one validation subject region Ab and another validation subject region Ab in an adjacent region between adjacent validation subject regions Ab.

More specifically, as shown in FIG. 5, the handoff region Ac between the front radar sensor 2a of which the validation subject region Ab is to the front and the front-side radar sensor 2b of which the validation subject region Ab is to the side and toward the front includes the following regions:
an overlapping region between the front subject region Abf and the front-side subject region Abs;
a portion of the front subject region Abf near the front-side subject region Abs; and
a portion of the front-side subject region Abs near the front subject region Abf.

In a similar manner, the handoff region Ac between the front-side radar sensor 2b of which the validation subject region Ab is to the side and toward the front, and the rear-side radar sensor 2c of which the validation subject region Ab is to the side and toward the rear includes the following regions:
a portion between the front-side subject region Abs and the rear-side subject region Abb that belongs to neither;
a portion of the front-side subject region Abs near the rear-side subject region Abb; and
a portion of the rear-side subject region Abb near the front-side subject region Abs.

The handoff determining unit 423 determines whether the handoff of the target detection information between the radar sensors 2 having adjacent detection ranges Aa is possible. Specifically, in a case in which a target detected within a certain validation subject region Ab and of which the target detection information is acquired is subsequently detected inside the handoff region Ac and outside the validation subject region Ab, the handoff determining unit 423 continues to use the target detection information as valid information in the handoff region Ac. The validation subject region Ab can also be referred to as a “priority area” because the target detected within the validation subject region Ab is given priority in terms of the handoff of the target detection information within the handoff region Ac. The term “priority” may be used in this sense in the descriptions hereafter.

Here, the “target detection information” to be handed off or continuously used refers to information related to a tracking state of a target. The information related to the tracking state of a target includes a target number or an identification number such as “target [1]”, “target [2]”, and so on, and a tracking status indicating whether tracking is being continued or has been lost.

### Operational Overview

An overview of an operation of the target recognition apparatus 4 according to the present embodiment will be described below, together with effects implemented by a target recognition method and a target recognition program that is a computer program executable by the target recognition apparatus 4. Here, the target recognition apparatus 4 according to the present embodiment, the target recognition method and the target recognition program executed thereby, and a non-transitory, tangible, computer-readable storage medium on which the target recognition program is recorded may be collectively referred to, hereafter, as “the present embodiment”.

The detection accuracy of the radar sensor 2 decreases in the wide-angle regions. This decrease in detection accuracy may become an issue particularly during the handoff of target detection information between the radar sensors 2 having adjacent detection ranges Aa. As a result of the handoff being favorably performed, appropriate vehicle control by an application in ADAS or a driver assistance/autonomous driving system, such as inter-vehicle distance control, lane change control, and collision avoidance control, can be ensured.

Therefore, according to the present embodiment, a predetermined range in the central area in terms of azimuth angle in which the radar sensor 2 is able to detect targets with relatively high accuracy is set as the validation subject region Ab. In addition, according to the present embodiment, the handoff region Ac is set between adjacent validation subject regions Ab. Furthermore, according to the present embodiment, if a target is that which has been detected even once in the validation subject region Ab, the corresponding target detection information is continuously used in the handoff region Ac until a target detected by the adjacent radar sensor 2 is linked.

In other words, according to the present embodiment, the target detection information, that is, the tracking state, corresponding to a first target detected in the validation subject region Ab of a certain radar sensor 2 is continuously used as valid target detection information, even if the target subsequently is detected within the handoff region Ac and outside the validation subject region Ab. In addition, according to the present embodiment, when the target is grouped as a same target as a second target detected within the validation subject region Ab of another radar sensor 2 having an adjacent detection range Aa and within the handoff region Ac, continued use of the target detection information is ended. Consequently, reliability of the target information can be improved while loss of targets is suppressed.

### Operation Example 1

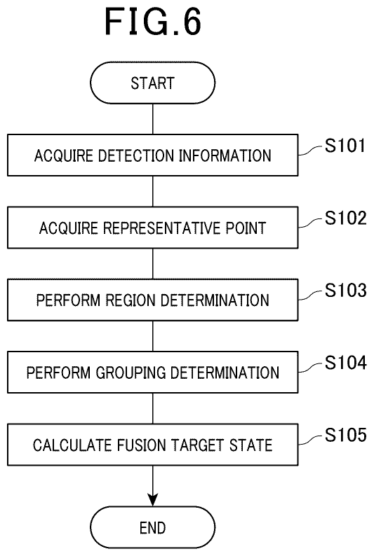

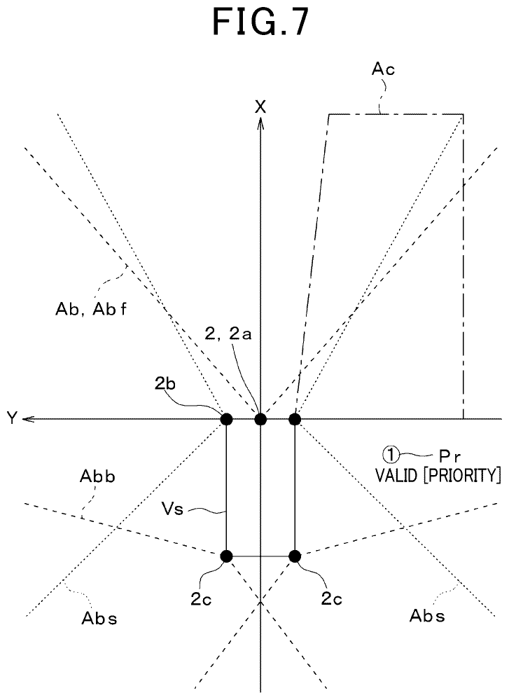

A specific example of the operation of the target recognition apparatus 4 according to the present embodiment will be described with reference to a flowchart shown in FIG. 6 and specific examples shown in FIG. 7 to FIG. 11, in addition to FIG. 1 to FIG. 5. Here, in the flowchart shown in FIG. 6, “S” is an abbreviation for “step”. In addition, circled numbers in FIG. 7 and the like indicate target numbers, and are expressed in the specification as, for example, target [1]. The present specific example assumes a situation in which another vehicle traveling to the right of the own vehicle Vs overtakes the own vehicle Vs, that is, a situation in which the handoff of target detection information between the front-side radar sensor 2b and the front radar sensor 2a is performed.

The processor 41 in the target recognition apparatus 4 will be simply referred to, hereafter, as the “processor 41”. In a similar manner, the storage medium 42 in the target recognition apparatus 4 will be simply referred to, hereafter, as the “storage medium 42”. The processor 41 reads out a routine shown in FIG. 6 that corresponds to the target recognition program from the storage medium 42 and performs the routine at predetermined intervals (for example, every 10 msec). In this routine, first, the processor 41 performs a process at step S101.

At step S101, the processor 41 acquires the detection information from the radar sensors 2 and the driving state sensor 3. That is, the processor 41 receives the detection information from the radar sensors 2 and the driving state sensor 3, and stores the detection information at least temporarily in the storage medium 42. The process at step S101 corresponds to a function or an operation of the detection information acquiring unit 401 shown in FIG. 3.

Subsequently, the processor 41 performs processes at step S102 to step S105 in order, and then temporarily ends the present routine. The processes at step S102 to step S105 correspond to a function or an operation of the recognition result generating unit 402 shown in FIG. 3.

At step S102, the processor 41 acquires the position of the representative point Pr based on the detection information acquired at step S101. At step S103, the processor 41 performs region determination based on the result of position acquisition at step S102. The region determination is fusion subject determination based on the region in which the target, that is, the representative point Pr, is located. Details of the region determination will be described below.

As shown in FIG. 7, regarding a target [1] detected within the front-side subject region Abs that is the validation subject region Ab of the front-side radar sensor 2b, the processor 41 sets a fusion subject determination result for a front-side radar target to valid [priority]. The “front-side radar target” refers to the target detected by the front-side radar sensor 2b. In a similar manner, a “front radar target” refers to the target detected by the front radar sensor 2a. A “rear-side radar target” refers to the target detected by the rear-side radar sensor 2c.

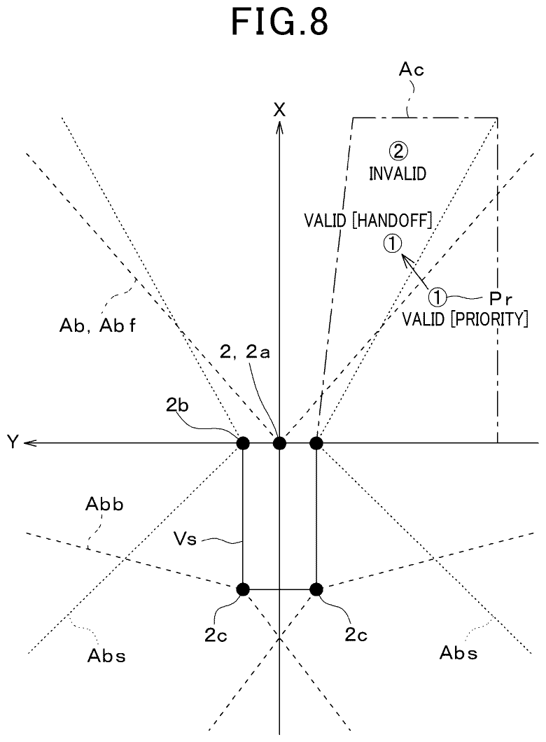

FIG. 8 shows a state in which another vehicle that is an actual object corresponding to the target [1] has moved from the state shown in FIG. 7 and reached the front-right side of the own vehicle Vs. At this time, the target detected within the front-side subject region Abs and the handoff region Ac is tracked as the same target as the target [1] of which the fusion subject determination result as the front-side radar target is valid [priority]. This target [1] has a history of having valid [priority] as the fusion subject determination result within the front-side target region Abs.

In this manner, regarding the target [1] that has once experienced being in the handoff region Ac and the front-side subject region Abs, the fusion subject determination result is valid [handoff] even if the other vehicle that is the actual object corresponding thereto subsequently is detected within the handoff region Ac and outside the front-side subject region Abs as a result of moving, as indicated by an arrow in FIG. 8. Meanwhile, regarding a target [2] that has never experienced being in the front-side subject region Abs, and is detected within the handoff region Ac and outside the front-side subject region Abs, the fusion subject determination result as the front-side radar target is invalid.

With reference, once again, to FIG. 6, at step S104, the processor 41 performs grouping determination. Then, at step S105, the processor 41 acquires, that is, calculates, the fusion target Tf based on the result of the grouping determination at step S104. Specifically, the processor 41 calculates the rectangle representing the fusion target Tf and the state (relative movement direction, relative speed, and the like) thereof. The output unit 403 outputs the calculation results.

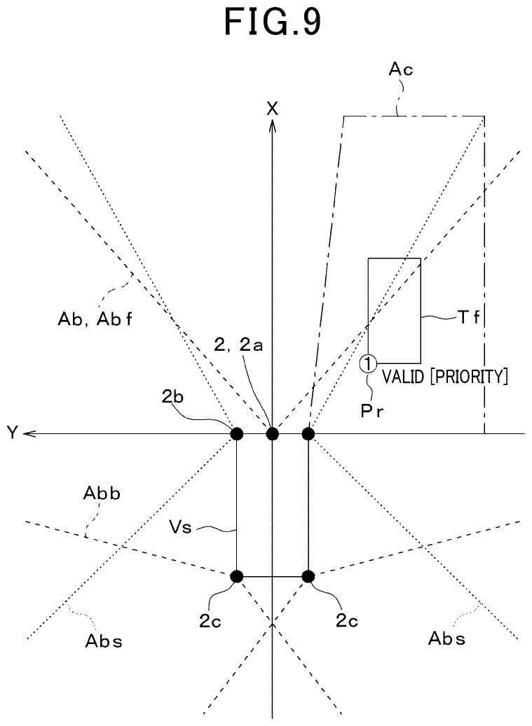

FIG. 9 to FIG. 12 show a specific example of the grouping determination. More specifically, FIG. 9 to FIG. 11 show an overview of target detection accompanying relative movement of another vehicle relative to the own vehicle Vs, the other vehicle being positioned on the front-right side of the own vehicle Vs. In addition, FIG. 12 shows examples of determinations corresponding to the states in FIG. 9 to FIG. 11 in table format. In FIG. 12, “FSN” is an abbreviation for “fusion”. “FRD” is an abbreviation for the front radar sensor 2a. “FSR” is an abbreviation for the front-side radar sensor 2b.

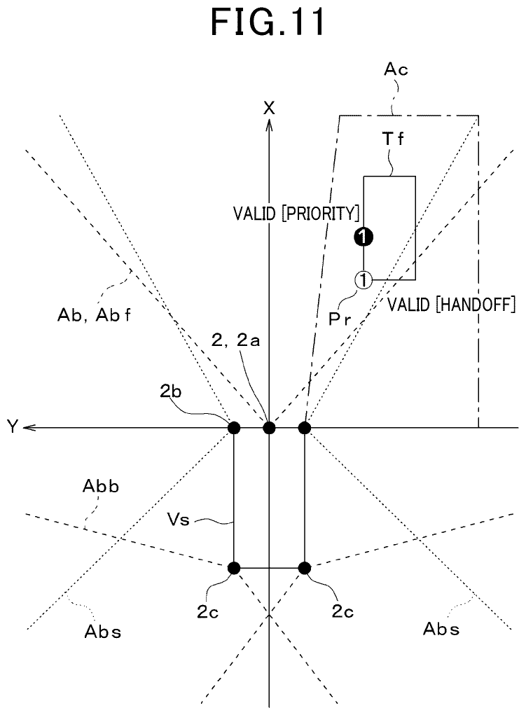

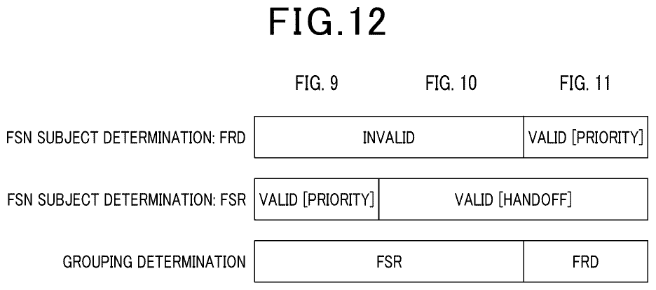

FIG. 9 shows a state in which the front-side radar target [1] is detected within the front-side subject region Abs that is the validation subject region Ab of the front-side radar sensor 2b. In this state, because the front-side radar target [1] is detected within the front-side subject region Abs, the fusion subject determination result is valid [priority] as shown in FIG. 11 and FIG. 12. That is, the front-side radar target [1] is determined to be a fusion subject and is established as a fusion target. Meanwhile, no target is detected in the front subject region Abf that is the validation subject region Ab of the front radar sensor 2a. Therefore, as shown in FIG. 12, the fusion subject determination result for the front radar target is invalid.

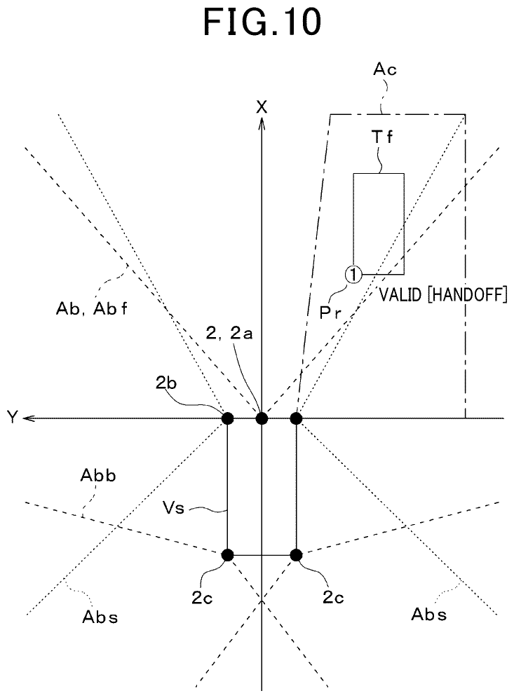

FIG. 10 shows a state in which, after the front-side radar target [1] has experienced being in the front-side subject region Abs that the validation subject region Ab, the front-side radar target [1] continues to be detected within the handoff region Ac while being outside the front-side subject region Abs as a result of relative movement of the actual other vehicle relative to the own vehicle Vs. In this state, as shown in FIG. 12, the fusion subject determination result is valid [handoff]. Grouping is continued and the fusion target is established.

In FIG. 11, the relative position of the actual other vehicle relative to the own vehicle Vs is assumed to have not moved from the state shown in FIG. 10. Therefore, the front-side radar target [1] continues to be detected in the handoff region Ac. However, the front radar target [1] is detected within the front subject region Abf that is the validation subject region Ab of the front radar sensor 2a, by the observation point corresponding to the other vehicle.

In this case, as shown in FIG. 11 and FIG. 12, because the front radar target [1] is detected within the front subject region Abf that is the validation subject region Ab of the front radar sensor 2a, the fusion subject determination result is valid [priority]. As a result, the front radar target [1] is also grouped and, therefore, the handoff of the target detection information between the front-side radar target [1] and the front radar target [1] is favorably performed. That is, the target tracking state is handed off without loss between the front-side radar target [1] recognized in the state in FIG. 9 and the front radar target [1] recognized in the state in FIG. 11.

Once the handoff is completed in this manner, the grouping of the front-side radar target [1] is subsequently canceled and the front radar target [1] is established as the fusion target. That is, the continuous use of the target detection information is ended.

(Operation example 2)

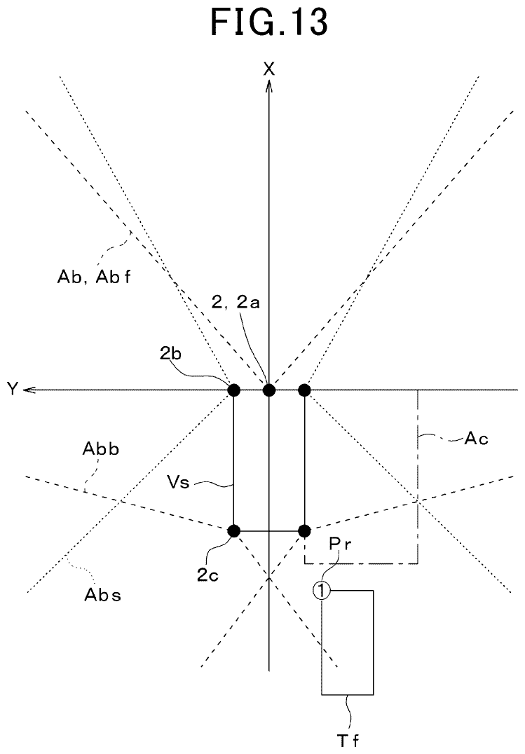

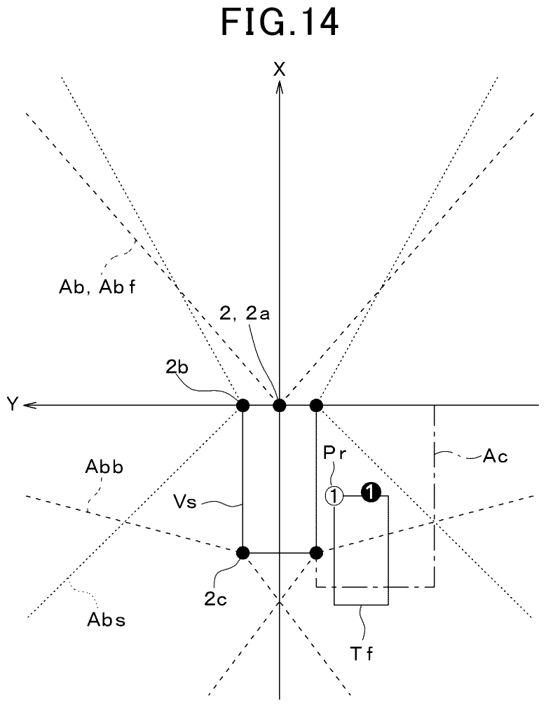

Another specific example will be described below. As shown in FIG. 13 and FIG. 14, in the present specific example, a situation in which the handoff of target detection information between the rear-side radar sensor 2c and the front-side radar sensor 2b is performed is assumed. Such a situation occurs, for example, when another vehicle traveling on the rear-right side of the own vehicle Vs catches up to and overtakes the own vehicle Vs.

In the present specific example, the handoff region Ac is set between the front-side subject region Abs that is the validation subject region Ab of the front-side radar sensor 2b, and the rear-side subject region Abb that is the validation subject region Ab of the rear-side radar sensor 2c. The handoff region Ac is mainly wide-angle regions of both the front-side radar sensor 2b and the rear-side radar sensor 2c. That is, the handoff region Ac includes much of the area outside the front-side subject region Abs and the rear-side subject region Abb. Therefore, the handoff region Ac is an area that uses the front-side radar target and the rear-side radar target.

Specifically, first, as shown in FIG. 13, the rear-side radar target [1] is detected in the rear-side subject region Abb that is the validation subject region Ab of the rear-side radar sensor 2c and is established as the fusion target. Next, in accompaniment with movement of the other vehicle, the rear-side radar target [1] is detected within the handoff region Ac but outside the rear-side subject region Abb and the front-side subject region Abs, as shown in FIG. 14. In addition, the front-side radar target [1] is detected within the handoff region Ac, but outside the rear-side subject region Abb and outside the front-side subject region Abs.

At this time, the rear-side radar target [1] has experienced being in the rear-side subject region Abb, that is, the validation subject region Ab, and has been present therein for a long period. Therefore, the rear-side radar target [1] is prioritized and established as the fusion target. Subsequently, when the front-side radar target [1] is detected in the front-side subject region Abs that is the validation subject region Ab, and is thereby prioritized and established as the fusion target, the continued use of the target detection information of the rear-side radar target [1] ends. As a result, occurrence of tracking loss can be favorably suppressed even for a target that has entered the wide-angle regions of both adjacent radar sensors 2.

### Summary of Effects

If tracking of a target fails, the target cannot be stably detected over time, and positional changes of the target in time-series cannot be tracked. As a result, operations on the application side will require caution. For example, an application in an inter-vehicle distance control system may instruct the driver to grip a steering wheel when another vehicle cuts in from an adjacent lane during hands-off control. The instruction is delayed if the cut-in vehicle is not properly detected.

In this regard, according to the present embodiment, the application can operate reliability in similar situations every time. Specifically, for example, smooth control and a sense of security can be obtained through prompt control and start of notification. In addition, when human-machine interface (HMI) display is performed using a head-up display or the like, the display is stable.

Furthermore, depending on quantity, positions, and angles of the radar sensors 2, a configuration in which the amount of overlap of the fusion subject regions between the sensors is reduced may be possible, as described above, on the rear side as well. In such a configuration, in a manner similar to that on the front side, if tracking of the target fails, lane determination of a subject rear vehicle may not be correctly performed in a lane-change assistance application, leading to erroneous permission and erroneous suppression of lane change. In this regard, according to the present embodiment, lane change determination is stabilized.

Moreover, according to the present embodiment, a following advantage can be obtained by positional accuracy and tracking ability being ensured, and the front-side radar sensor 2b and the rear-side radar sensor 2c being selectively used. In other words, in an application that makes a vehicle maintain a traffic lane while ensuring sufficient space on both left and right sides when traveling alongside or overtaking another vehicle traveling in an adjacent lane, accuracy of a lateral position of a target in an area beside the vehicle Vs becomes important. In this regard, according to the present embodiment, lane keeping control is able to be performed at a timing that does not cause a user discomfort.

### Modifications

The present disclosure is not limited to the embodiment and specific examples described above. Therefore, the above-described embodiment and the like can be modified as appropriate. Representative modifications will be described below.

The present disclosure is not limited to the specific uses and apparatus configurations described according to the embodiment above. That is, for example, the own vehicle Vs may be a so-called standard automobile or a large-size automobile.

The driving assistance apparatus 4 may be an object detection ECU or the driving control ECU. All or part of the target recognition apparatus 4 may be configured to include a digital circuit, such as an application-specific integrated circuit (ASIC) or a field-programmable gate array (FPGA), configured to be capable of actualizing the functions or operations described above. That is, in the target recognition apparatus 4, an in-vehicle microcomputer portion and a digital circuit portion can both be present.

A computer program of the present disclosure that enables the various operations, procedures, or processes described according to the embodiment, above, to be performed can be downloaded or upgraded through V2X communication using the communication apparatus 6. V2X stands for vehicle-to-X. Alternatively, the computer program can be downloaded or upgraded through a terminal apparatus provided at a manufacturing plant, a repair shop, a dealer, or the like, of the own vehicle Vs. The program may be stored in a memory card, an optical disc, a magnetic disk, or the like.

In this manner, the functional configurations and processes described above may be actualized by a dedicated computer that is provided such as to be configured by the processor 41 and the storage medium 42, the processor 41 being programmed to provide one or a plurality of functions that are realized by a computer program. Alternatively, the functional configurations and processes described above may be actualized by a dedicated computer that is provided by the processor 41 being configured by a single dedicated hardware logic circuit or more. Still alternatively, the functional configurations and processes described above may be actualized by a single dedicated computer or more. The dedicated computer may be configured by a combination of one or more of the processor 41 that is programmed to provide one or a plurality of functions, one or more of the storage medium 42, and one or more of another processor 41 that is configured by a single hardware logic circuit or more. In addition, the computer program may be stored in a non-transitory, tangible, computer-readable storage medium that can be read by a computer as instructions performed by the computer. That is, the functional configurations and processes described above can also be expressed as a computer program including steps to actualize the functional configurations and processes described above, or a non-transitory, tangible, computer-readable storage medium storing the computer program therein.

The present disclosure is not limited to the specific operation examples described according to the embodiment, above. That is, for example, the present disclosure may also be applied to a situation in which handoff of the target detection information between the front radar sensor 2a and the front-side radar sensor 2b is performed when the own vehicle Vs catches up to and overtakes the other vehicle from behind and to the side, in a manner opposite that of the first operation example described above. Similarly, the present disclosure may also be applied to a situation (such as merging) in which the own vehicle cuts in front of the other vehicle after passing by the side of the other vehicle, in a manner opposite the second operation example described above.

Similar expressions such as “acquire”, “calculate”, “estimate”, “detect”, and “sense” are interchangeable as long as technical conflicts do not occur. In addition, “exceeds a threshold” and “equal to or greater than a threshold” are interchangeable as long as technical conflicts do not occur. This similarly applies to “below a threshold” and “equal to or less than a threshold”.

It goes without saying that an element that configures the above-described embodiment is not necessarily a requisite unless particularly specified as being a requisite, clearly considered a requisite in principle, or the like. In addition, in cases in which a numeric value, such as quantity, numeric value, amount, or range, of a constituent element is mentioned, the present disclosure is not limited to the specific number unless particularly specified as being a requisite, clearly limited to the specific number in principle, or the like. In a similar manner, in cases in which a shape, direction, positional relationship, or the like of a constituent element or the like is mentioned, the present disclosure is not limited to the shape, direction, positional relationship, or the like unless particularly specified as being a requisite, clearly limited to the specific shape, direction, positional relationship, or the like in principle, or the like.

Modifications are also not limited to the examples given above. For example, one of the plurality of specific examples may be combined, in its entirety or in part, with another in its entirety or in part as long as technical conflicts do not occur. In a similar manner, one of the plurality of modifications may be combined, in its entirety or in part, with another in its entirety or in part as long as technical conflicts do not occur. Furthermore, the above-described specific example may be combined, in its entirety or in part, with an above-described modification in its entirety or in part as long as technical conflicts do not occur.

### Aspects of the Disclosure

The present specification discloses at least the disclosed matters below, as is clear from the descriptions of the embodiments and modifications above.

### [Aspect 1-1]

A target recognition apparatus (4) configured to recognize a target in a vicinity of a vehicle (Vs) when mounted in the vehicle, the target recognition apparatus including: at least one of (i) a circuit and (ii) a processor with a memory storing computer program code executable by the processor, the at least one of the circuit and the processor configured to implement: a detection information acquiring unit (401) that acquires target detection information from a first sensor and a second sensor that are radar sensors (2) having detection areas (Aa) that are adjacent in terms of azimuth angle; and a recognition result generating unit (402) that generates a recognition result of the target based on first target detection information that is the target detection information from the first sensor and second target detection information that is the target detection information from the second sensor, in which the recognition result generating unit, when a predetermined area that is a portion of the detection area and is in a central area in terms of azimuth angle is set as a validation subject area (Ab), the validation subject area of the first sensor is set as a first validation subject area and the validation subject area of the second sensor is set as a second validation subject area, and a predetermined region in which the first validation subject area and the second validation subject area are adjacent and includes at least a portion of the first validation subject area and a portion of the second validation subject area is set as a handoff region (Ac), in response to a first target that is the target detected within the first validation subject region and of which the first target information is acquired being subsequently detected within the handoff region and outside the first validation subject region, continuously uses the first target detection information as valid information within the handoff region.

### [Aspect 1-2]

The target recognition apparatus according to the aspect 1-1, in which: the recognition result generating unit, in response to a second target that is the target detected within the handoff region and of which the second target detection information is acquired being determined to be a same target as the first target detected within the handoff region and outside the first validation subject region, integrates the first target detection information and the second target detection information, and ends continued use of the first target detection information.

### [Aspect 1-3]

The target recognition apparatus according to the aspect 1-2, in which: a front radar sensor (21) that is the radar sensor of which the validation subject region is to the front and a front-side radar sensor (22) of which the validation subject region is to the side and toward the front are mounted in the vehicle; the first sensor is one of either of the front radar sensor and the front-side radar sensor; the second sensor is the other of the front radar sensor and the front-side radar sensor differing from the one; the handoff region includes an overlapping region between the first validation subject region and the second validation subject region, a region within the first validation subject region and outside the second validation subject region, and a region outside the first validation subject region and within the second validation subject region; and the recognition result generating unit, in response to the second target detected within the handoff region and within the second validation subject region being determined to be a same target as the first target detected within the handoff region and the second validation subject region after being detected within the handoff region and the first validation subject region, integrates the first target detection information and the second target detection information, and ends continued use of the first detection target information.

### [Aspect 1-4]

The target recognition apparatus according to the aspect 1-1 or 1-2, in which: a front-side radar sensor (22) that is the radar sensor of which the validation subject region is to the side and toward the front and a rear-side radar sensor (23) of which the validation subject region is to the side and toward the rear are mounted in the vehicle; the first sensor is one of either of the front-side radar sensor and the rear-side radar sensor; the second sensor is the other of the front-side radar sensor and the rear-side radar sensor differing from the one; the handoff region includes a region between the first validation subject region and the second validation subject region, a region within the first validation subject region and outside the second validation subject region, and a region outside the first validation subject region and within the second validation subject region; and the recognition result generating unit prioritizes, within the handoff region, the first target detection information corresponding to the target that has detection history in the validation subject region or the target that has been present for a long period in the validation subject region, and continuously uses the first target detection information.

### [Aspect 2-1]

A target recognition method for recognizing a target in a vicinity of a vehicle (Vs), the target recognition method including: acquiring target detection information from a first sensor and a second sensor that are radar sensors (2) having detection areas (Aa) that are adjacent in terms of azimuth angle; and generating a recognition result of the target based on first target detection information that is the target detection information from the first sensor and second target detection information that is the target detection information from the second sensor, in which in generating the recognition result, when a predetermined area that is a portion of the detection area and is in a central area in terms of azimuth angle is set as a validation subject area (Ab), the validation subject area of the first sensor is set as a first validation subject area and the validation subject area of the second sensor is set as a second validation subject area, and a predetermined region in which the first validation subject area and the second validation subject area are adjacent and includes at least a portion of the first validation subject area and a portion of the second validation subject area is set as a handoff region (Ac), in response to a first target that is the target detected within the first validation subject region and of which the first target information is acquired being subsequently detected within the handoff region and outside the first validation subject region, the first target detection information is continuously used as valid information within the handoff region.

[aspect 2-2]

The target recognition method according to the aspect 2-1, in which: in generating the recognition result, in response to a second target that is the target detected within the handoff region and of which the second target detection information is acquired being determined to be a same target as the first target detected within the handoff region and outside the first validation subject region, the first target detection information and the second target detection information are integrated, and continued use of the first target detection information is ended.

### [Aspect 2-3]

The target recognition method according to the aspect 2-2, in which: a front radar sensor (21) that is the radar sensor of which the validation subject region is to the front and a front-side radar sensor (22) of which the validation subject region is to the side and toward the front are mounted in the vehicle; the first sensor is one of either of the front radar sensor and the front-side radar sensor; the second sensor is the other of the front radar sensor and the front-side radar sensor differing from the one; the handoff region includes an overlapping region between the first validation subject region and the second validation subject region, a region within the first validation subject region and outside the second validation subject region, and a region outside the first validation subject region and within the second validation subject region; and in generating the recognition result, in response to the second target detected within the handoff region and within the second validation subject region is determined to be a same target as the first target detected within the handoff region and the second validation subject region after being detected within the handoff region and the first validation subject region, the first target detection information and the second target detection information are integrated, and continued use of the first detection target information is ended.

### [Aspect 2-4]

The target recognition method according to the aspect 2-1 or 2-2, in which: a front-side radar sensor (22) that is the radar sensor of which the validation subject region is to the side and toward the front and a rear-side radar sensor (23) of which the validation subject region is to the side and toward the rear are mounted in the vehicle; the first sensor is one of either of the front-side radar sensor and the rear-side radar sensor; the second sensor is the other of the front-side radar sensor and the rear-side radar sensor differing from the one; the handoff region includes a region between the first validation subject region and the second validation subject region, a region within the first validation subject region and outside the second validation subject region, and a region outside the first validation subject region and within the second validation subject region; and in generating the recognition result, the first target detection information corresponding to the target that has detection history in the validation subject region or the target that has been present for a long period in the validation subject region is prioritized and continuously used within the handoff region.

### [Aspect 3-1]

A target recognition program executable by a target recognition apparatus (4) configured to recognize a target in a vicinity of a vehicle (Vs) when mounted in the vehicle, the target recognition program including, as processes performed by the target recognition apparatus: a process for acquiring target detection information from a first sensor and a second sensor that are radar sensors (2) having detection areas (Aa) that are adjacent in terms of azimuth angle; and a process for generating a recognition result of the target based on first target detection information that is the target detection information from the first sensor and second target detection information that is the target detection information from the second sensor, in which in the process for generating the recognition result, when a predetermined area that is a portion of the detection area and is in a central area in terms of azimuth angle is set as a validation subject area (Ab), the validation subject area of the first sensor is set as a first validation subject area and the validation subject area of the second sensor is set as a second validation subject area, and a predetermined region in which the first validation subject area and the second validation subject area are adjacent and includes at least a portion of the first validation subject area and a portion of the second validation subject area is set as a handoff region (Ac), in response to a first target that is the target detected within the first validation subject region and of which the first target information is acquired being subsequently detected within the handoff region and outside the first validation subject region, the first target detection information is continuously used as valid information within the handoff region.

### [Aspect 3-2]

The target recognition program according to the aspect 3-1, in which: in the process for generating the recognition result, in response to a second target that is the target detected within the handoff region and of which the second target detection information is acquired being determined to be a same target as the first target detected within the handoff region and outside the first validation subject region, the first target detection information and the second target detection information are integrated, and continued use of the first target detection information is ended.

### [Aspect 3-3]

The non-transitory computer-readable storage medium according to the aspect 3-2, in which: a front radar sensor (21) that is the radar sensor of which the validation subject region is to the front and a front-side radar sensor (22) of which the validation subject region is to the side and toward the front are mounted in the vehicle; the first sensor is one of either of the front radar sensor and the front-side radar sensor; the second sensor is the other of the front radar sensor and the front-side radar sensor differing from the one; the handoff region includes an overlapping region between the first validation subject region and the second validation subject region, a region within the first validation subject region and outside the second validation subject region, and a region outside the first validation subject region and within the second validation subject region; and in the process for generating the recognition result, in response to the second target detected within the handoff region and within the second validation subject region being determined to be a same target as the first target detected within the handoff region and the second validation subject region after being detected within the handoff region and the first validation subject region, the first target detection information and the second target detection information are integrated, and continued use of the first detection target information is ended.

### [Aspect 3-4]

The target recognition program according to the aspect 3-1 or 3-2, in which: a front-side radar sensor (22) that is the radar sensor of which the validation subject region is to the side and toward the front and a rear-side radar sensor (23) of which the validation subject region is to the side and toward the rear are mounted in the vehicle; the first sensor is one of either of the front-side radar sensor and the rear-side radar sensor; the second sensor is the other of the front-side radar sensor and the rear-side radar sensor differing from the one; the handoff region includes a region between the first validation subject region and the second validation subject region, a region within the first validation subject region and outside the second validation subject region, and a region outside the first validation subject region and within the second validation subject region; and in the process for generating the recognition result, the first target detection information corresponding to the target that has detection history in the validation subject region or the target that has been present for a long period in the validation subject region is prioritized and continuously used within the handoff region.

### [Aspect 4-1]

A non-transitory computer-readable storage medium storing therein a target recognition program executable by a target recognition apparatus (4) configured to recognize a target in a vicinity of a vehicle (Vs) when mounted in the vehicle, the target recognition program including, as processes performed by the target recognition apparatus: a process for acquiring target detection information from a first sensor and a second sensor that are radar sensors (2) having detection areas (Aa) that are adjacent in terms of azimuth angle; and a process for generating a recognition result of the target based on first target detection information that is the target detection information from the first sensor and second target detection information that is the target detection information from the second sensor, in which in the process for generating the recognition result, when a predetermined area that is a portion of the detection area and is in a central area in terms of azimuth angle is set as a validation subject area (Ab), the validation subject area of the first sensor is set as a first validation subject area and the validation subject area of the second sensor is set as a second validation subject area, and a predetermined region in which the first validation subject area and the second validation subject area are adjacent and includes at least a portion of the first validation subject area and a portion of the second validation subject area is set as a handoff region (Ac), in response to a first target that is the target detected within the first validation subject region and of which the first target information is acquired being subsequently detected within the handoff region and outside the first validation subject region, the first target detection information is continuously used as valid information within the handoff region.

### [Aspect 4-2]

The non-transitory computer-readable storage medium according to the aspect 4-1, in which: in the process for generating the recognition result, in response to a second target that is the target detected within the handoff region and of which the second target detection information is acquired being determined to be a same target as the first target detected within the handoff region and outside the first validation subject region, the first target detection information and the second target detection information are integrated, and continued use of the first target detection information is ended.

### [Aspect 4-3]

The non-transitory computer-readable storage medium according to the aspect 4-2, in which: a front radar sensor (21) that is the radar sensor of which the validation subject region is to the front and a front-side radar sensor (22) of which the validation subject region is to the side and toward the front are mounted in the vehicle; the first sensor is one of either of the front radar sensor and the front-side radar sensor; the second sensor is the other of the front radar sensor and the front-side radar sensor differing from the one; the handoff region includes an overlapping region between the first validation subject region and the second validation subject region, a region within the first validation subject region and outside the second validation subject region, and a region outside the first validation subject region and within the second validation subject region; and in the process for generating the recognition result, in response to the second target detected within the handoff region and within the second validation subject region being determined to be a same target as the first target detected within the handoff region and the second validation subject region after being detected within the handoff region and the first validation subject region, the first target detection information and the second target detection information are integrated, and continued use of the first detection target information is ended.

### [Aspect 4-4]

The non-transitory computer-readable storage medium according to the aspect 4-1 or 4-2, in which: a front-side radar sensor (22) that is the radar sensor of which the validation subject region is to the side and toward the front and a rear-side radar sensor (23) of which the validation subject region is to the side and toward the rear are mounted in the vehicle; the first sensor is one of either of the front-side radar sensor and the rear-side radar sensor; the second sensor is the other of the front-side radar sensor and the rear-side radar sensor differing from the one; the handoff region includes a region between the first validation subject region and the second validation subject region, a region within the first validation subject region and outside the second validation subject region, and a region outside the first validation subject region and within the second validation subject region; and in the process for generating the recognition result, the first target detection information corresponding to the target that has detection history in the validation subject region or the target that has been present for a long period in the validation subject region is prioritized and continuously used within the handoff region.

What is claimed is:

1. A target recognition apparatus configured to recognize a target in a vicinity of a vehicle when mounted in the vehicle, the target recognition apparatus comprising:
at least one of (i) a circuit and (ii) a processor with a memory storing computer program code executable by the processor, the at least one of the circuit and the processor configured to implement:
a detection information acquiring unit that acquires target detection information from a first sensor and a second sensor that are radar sensors having detection areas that are adjacent in terms of azimuth angle; and
a recognition result generating unit that generates a recognition result of the target based on first target detection information that is the target detection information from the first sensor and second target detection information that is the target detection information from the second sensor, wherein
the recognition result generating unit,
when a predetermined area that is a portion of the detection area and is in a central area in terms of azimuth angle is set as a validation subject area, the validation subject area of the first sensor is set as a first validation subject area and the validation subject area of the second sensor is set as a second validation subject area, and a predetermined region in which the first validation subject area and the second validation subject area are adjacent and includes at least a portion of the first validation subject area and a portion of the second validation subject area is set as a handoff region,
in response to a first target that is the target detected within the first validation subject region and of which the first target information is acquired being subsequently detected within the handoff region and outside the first validation subject region,
continuously uses the first target detection information as valid information within the handoff region.

2. The target recognition apparatus according to claim 1, wherein:
the recognition result generating unit, in response to a second target that is the target detected within the handoff region and of which the second target detection information is acquired being determined to be a same target as the first target detected within the handoff region and outside the first validation subject region, integrates the first target detection information and the second target detection information, and ends continued use of the first target detection information.

3. The target recognition apparatus according to claim 2, wherein:
a front radar sensor that is the radar sensor of which the validation subject region is to the front and a front-side radar sensor of which the validation subject region is to the side and toward the front are mounted in the vehicle;
the first sensor is one of either of the front radar sensor and the front-side radar sensor;
the second sensor is the other of the front radar sensor and the front-side radar sensor differing from the one;
the handoff region includes an overlapping region between the first validation subject region and the second validation subject region, a region within the first validation subject region and outside the second validation subject region, and a region outside the first validation subject region and within the second validation subject region; and
the recognition result generating unit, in response to the second target detected within the handoff region and within the second validation subject region being determined to be a same target as the first target detected within the handoff region and the second validation subject region after being detected within the handoff region and the first validation subject region, integrates the first target detection information and the second target detection information, and ends continued use of the first detection target information.

4. The target recognition apparatus according to claim 2, wherein:
a front-side radar sensor that is the radar sensor of which the validation subject region is to the side and toward the front and a rear-side radar sensor of which the validation subject region is to the side and toward the rear are mounted in the vehicle;
the first sensor is one of either of the front-side radar sensor and the rear-side radar sensor;
the second sensor is the other of the front-side radar sensor and the rear-side radar sensor differing from the one;
the handoff region includes a region between the first validation subject region and the second validation subject region, a region within the first validation subject region and outside the second validation subject region, and a region outside the first validation subject region and within the second validation subject region; and
the recognition result generating unit prioritizes, within the handoff region, the first target detection information corresponding to the target that has detection history in the validation subject region or the target that has been present for a long period in the validation subject region, and continuously uses the first target detection information.

5. A target recognition method for recognizing a target in a vicinity of a vehicle, the target recognition method comprising:
acquiring target detection information from a first sensor and a second sensor that are radar sensors having detection areas that are adjacent in terms of azimuth angle; and
generating a recognition result of the target based on first target detection information that is the target detection information from the first sensor and second target detection information that is the target detection information from the second sensor, wherein
in generating the recognition result,
when a predetermined area that is a portion of the detection area and is in a central area in terms of azimuth angle is set as a validation subject area, the validation subject area of the first sensor is set as a first validation subject area and the validation subject area of the second sensor is set as a second validation subject area, and a predetermined region in which the first validation subject area and the second validation subject area are adjacent and includes at least a portion of the first validation subject area and a portion of the second validation subject area is set as a handoff region,
in response to a first target that is the target detected within the first validation subject region and of which the first target information is acquired being subsequently detected within the handoff region and outside the first validation subject region,
the first target detection information is continuously used as valid information within the handoff region.

6. The target recognition method according to claim 5, wherein:
in generating the recognition result, in response to a second target that is the target detected within the handoff region and of which the second target detection information is acquired being determined to be a same target as the first target detected within the handoff region and outside the first validation subject region, the first target detection information and the second target detection information are integrated, and continued use of the first target detection information is ended.

7. The target recognition method according to claim 6, wherein:
a front radar sensor that is the radar sensor of which the validation subject region is to the front and a front-side radar sensor of which the validation subject region is to the side and toward the front are mounted in the vehicle;
the first sensor is one of either of the front radar sensor and the front-side radar sensor;
the second sensor is the other of the front radar sensor and the front-side radar sensor differing from the one;
the handoff region includes an overlapping region between the first validation subject region and the second validation subject region, a region within the first validation subject region and outside the second validation subject region, and a region outside the first validation subject region and within the second validation subject region; and
in generating the recognition result, in response to the second target detected within the handoff region and within the second validation subject region is determined to be a same target as the first target detected within the handoff region and the second validation subject region after being detected within the handoff region and the first validation subject region, the first target detection information and the second target detection information are integrated, and continued use of the first detection target information is ended.

8. The target recognition method according to claim 6, wherein:
a front-side radar sensor that is the radar sensor of which the validation subject region is to the side and toward the front and a rear-side radar sensor of which the validation subject region is to the side and toward the rear are mounted in the vehicle;
the first sensor is one of either of the front-side radar sensor and the rear-side radar sensor;
the second sensor is the other of the front-side radar sensor and the rear-side radar sensor differing from the one;
the handoff region includes a region between the first validation subject region and the second validation subject region, a region within the first validation subject region and outside the second validation subject region, and a region outside the first validation subject region and within the second validation subject region; and
in generating the recognition result, the first target detection information corresponding to the target that has detection history in the validation subject region or the target that has been present for a long period in the validation subject region is prioritized and continuously used within the handoff region.

9. A non-transitory computer-readable storage medium storing therein a target recognition program executable by a target recognition apparatus configured to recognize a target in a vicinity of a vehicle when mounted in the vehicle, the target recognition program comprising, as processes performed by the target recognition apparatus:
a process for acquiring target detection information from a first sensor and a second sensor that are radar sensors having detection areas that are adjacent in terms of azimuth angle; and
a process for generating a recognition result of the target based on first target detection information that is the target detection information from the first sensor and second target detection information that is the target detection information from the second sensor, wherein
in the process for generating the recognition result,
when a predetermined area that is a portion of the detection area and is in a central area in terms of azimuth angle is set as a validation subject area, the validation subject area of the first sensor is set as a first validation subject area and the validation subject area of the second sensor is set as a second validation subject area, and a predetermined region in which the first validation subject area and the second validation subject area are adjacent and includes at least a portion of the first validation subject area and a portion of the second validation subject area is set as a handoff region,
in response to a first target that is the target detected within the first validation subject region and of which the first target information is acquired being subsequently detected within the handoff region and outside the first validation subject region,
the first target detection information is continuously used as valid information within the handoff region.

10. The non-transitory computer-readable storage medium according to claim 9, wherein:
in the process for generating the recognition result, in response to a second target that is the target detected within the handoff region and of which the second target detection information is acquired being determined to be a same target as the first target detected within the handoff region and outside the first validation subject region, the first target detection information and the second target detection information are integrated, and continued use of the first target detection information is ended.

11. The non-transitory computer-readable storage medium according to claim 10, wherein:
a front radar sensor that is the radar sensor of which the validation subject region is to the front and a front-side radar sensor of which the validation subject region is to the side and toward the front are mounted in the vehicle;
the first sensor is one of either of the front radar sensor and the front-side radar sensor;
the second sensor is the other of the front radar sensor and the front-side radar sensor differing from the one;
the handoff region includes an overlapping region between the first validation subject region and the second validation subject region, a region within the first validation subject region and outside the second validation subject region, and a region outside the first validation subject region and within the second validation subject region; and
in the process for generating the recognition result, in response to the second target detected within the handoff region and within the second validation subject region being determined to be a same target as the first target detected within the handoff region and the second validation subject region after being detected within the handoff region and the first validation subject region, the first target detection information and the second target detection information are integrated, and continued use of the first detection target information is ended.

12. The non-transitory computer-readable storage medium according to claim 10, wherein:
a front-side radar sensor that is the radar sensor of which the validation subject region is to the side and toward the front and a rear-side radar sensor of which the validation subject region is to the side and toward the rear are mounted in the vehicle;
the first sensor is one of either of the front-side radar sensor and the rear-side radar sensor;
the second sensor is the other of the front-side radar sensor and the rear-side radar sensor differing from the one;
the handoff region includes a region between the first validation subject region and the second validation subject region, a region within the first validation subject region and outside the second validation subject region, and a region outside the first validation subject region and within the second validation subject region; and
in the process for generating the recognition result, the first target detection information corresponding to the target that has detection history in the validation subject region or the target that has been present for a long period in the validation subject region is prioritized and continuously used within the handoff region.
